(19) United States
(12) Patent Application Publication
(10) Pub. No.: US 2016/0232057 A1
(43) Pub. Date: Aug. 11, 2016

(54) SAFE MODE BOOT LOADER

(71) Applicant: SanDisk Technologies Inc., Plano, TX (US)

(72) Inventors: Arie Star, Hadera (IL); Inon Cohen, Oranit (IL); Avi Shchislowski, Kadima (IL)

(73) Assignee: SANDISK TECHNOLOGIES INC., Plano, TX (US)

(21) Appl. No.: 14/619,486

(22) Filed: Feb. 11, 2015

(51) Int. Cl. G06F 11/14; G06F 9/44

(52) U.S. Cl. CPC G06F 11/1417; G06F 9/4406

(57) ABSTRACT

A storage device with a memory may have an alternative safe mode boot loading process. Upon detecting a malfunction, the storage device may activate a safe mode in which a safe mode boot loader is stored in memory of the storage device that is not logically mapped. The safe mode allows for recovery and debugging by the host that may not otherwise be possible without the safe mode process.

### TECHNICAL FIELD

This application relates generally to memory devices. More specifically, this application relates to a process for handling a malfunction in non-volatile semiconductor flash memory and providing a safe mode boot loading process for a host.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. The booting of a computing system (e.g. a host device and memory with the operating system) may be referred to as the initialization of the operating system. A boot loader may be a program that is stored in non-volatile memory that is loaded by Read Only Memory (ROM) into Read Access Memory (RAM) by reading it from a known logical address in the non-volatile memory. The boot loader may be used for accessing the operating system programs and data. If the storage device malfunctions (e.g. failing to respond to host read commands or returning corrupted boot loader code), then the device may not be able to boot and recovery/debugging may be difficult without host access.

### SUMMARY

A storage device with a memory may have an alternative safe mode boot loading process. The storage device memory may include the operating system for the host, such that a malfunction may prevent all operation. In one embodiment, the storage device itself may detect a malfunction and activate a safe mode using a safe mode boot loader. The safe mode boot loader may be stored in memory of the storage device that is not logically mapped. The safe mode allows for recovery and debugging by the host that may not otherwise be possible without the safe mode process.

### BRIEF DESCRIPTION OF THE DRAWINGS

FIG. 1A is a block diagram of an example non-volatile memory system.

FIG. 1B is a block diagram of a storage module that includes a plurality of non-volatile memory systems.

FIG. 1C is a block diagram of a hierarchical storage system.

FIG. 2A is a block diagram of exemplary components of a controller of a non-volatile memory system.

FIG. 2B is a block diagram of exemplary components of a non-volatile memory of a non-volatile memory storage system.

FIG. 3 is a block diagram of another exemplary memory system using a safe mode boot loader.

FIG. 4 is a flow diagram illustrating safe mode boot loading.

FIG. 5 is a block diagram of another exemplary memory system using a safe mode boot loader.

FIG. 6 is a flow diagram illustrating entry into a safe mode boot loading process.

FIG. 7 is a flow diagram illustrating another embodiment of safe mode boot loading.

### DESCRIPTION OF THE EMBODIMENTS

In various computing environments including a storage device or memory system, the booting process is the initialization of a computerized system. When a computing device is powered on, it typically does not have an operating system in random access memory (RAM). The computing device first executes a relatively small program stored in read-only memory (ROM) along with a small amount of needed data, to access the nonvolatile storage or devices from which the operating system programs and data can be loaded into RAM. The program in the ROM accesses a boot loader from the non-volatile memory. A boot loader is a computer program that loads an operating system or other software for the computing device after completion of various self-tests operations. The boot loader may be loaded into main memory (e.g. RAM) from persistent memory (e.g. non-volatile storage as a hard disk drive) for executing the processes that finalize the boot. During boot time, the host reads a known logical area where its boot loader is stored in the non-volatile storage device. If the storage device malfunctions, failing to respond to host read commands or returning corrupted boot loader code, then the host operating system (OS) may not be able to boot. The inability of OS booting, may reduce the recovery and debugging capabilities of both the host vendor and the storage device vendor.

The embodiments described below include a computing system (host and storage device, which may be collectively referred to as a memory system) that includes a safe mode operation. In the storage device memory is a safe mode boot loader that is stored in an area of the memory that is not logically addressed. Upon detection of a malfunction, the safe mode boot loader allows the host to boot. The host may then run debugging and/or recovery software to correct the malfunction.

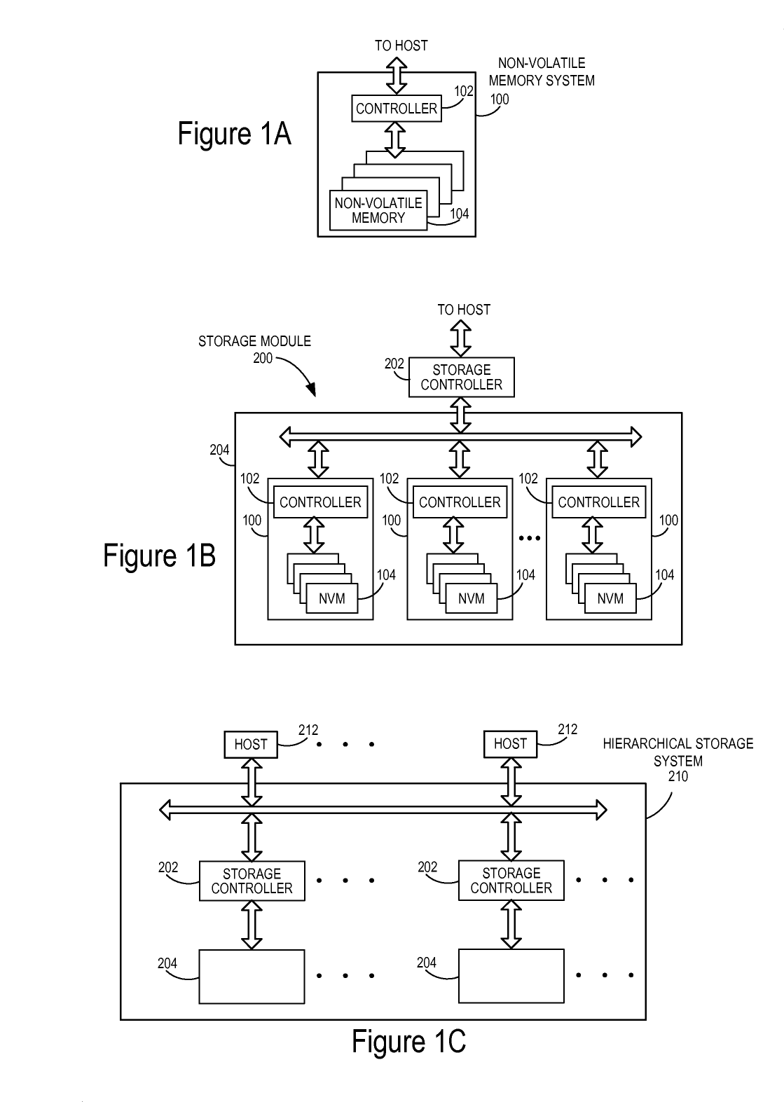

FIG. 1A is a block diagram illustrating a non-volatile memory system. The non-volatile memory system 100 includes a controller 102 and non-volatile memory that may be made up of one or more non-volatile memory die 104. As used herein, the term die refers to the set of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104. The non-volatile memory die 104 may store an operating system for the host.

Examples of host systems include, but are not limited to, personal computers (PCs), such as desktop or laptop and other portable computers, tablets, mobile devices, cellular telephones, smartphones, personal digital assistants (PDAs), gaming devices, digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip. The host may communicate with the memory card using any communication protocol such as but not limited to Secure Digital (SD) protocol, Memory Stick (MS) protocol and Universal Serial Bus (USB) protocol.

The controller 102 (which may be a flash memory controller) can take the form of processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host needs to read data from or write data to the flash memory, it will communicate with the flash memory controller. If the host provides a logical address to which data is to be read/written, the flash memory controller can convert the logical address received from the host to a physical address in the flash memory. (Alternatively, the host can provide the physical address). The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, memory system 100 may be a card based system, such as a secure digital (SD) or a micro secure digital (micro-SD) card. In an alternate embodiment, memory system 100 may be part of an embedded memory system. For example, the flash memory may be embedded within the host, such as in the form of a solid state disk (SSD) drive installed in a personal computer.

Although in the example illustrated in FIG. 1A, non-volatile memory system 100 includes a single channel between controller 102 and non-volatile memory die 104, the subject matter described herein is not limited to having a single memory channel. For example, in some NAND memory system architectures, such as in FIGS. 1B and 1C, 2, 4, 8 or more NAND channels may exist between the controller and the NAND memory device, depending on controller capabilities. In any of the embodiments described herein, more than a single channel may exist between the controller and the memory die, even if a single channel is shown in the drawings.

FIG. 1B illustrates a storage module 200 that includes plural non-volatile memory systems 100. As such, storage module 200 may include a storage controller 202 that interfaces with a host and with storage system 204, which includes a plurality of non-volatile memory systems 100. The interface between storage controller 202 and non-volatile memory systems 100 may be a bus interface, such as a serial advanced technology attachment (SATA) or peripheral component interface express (PCIe) interface. Storage module 200, in one embodiment, may be a solid state drive (SSD), such as found in portable computing devices, such as laptop computers, and tablet computers.

FIG. 1C is a block diagram illustrating a hierarchical storage system. A hierarchical storage system 210 includes a plurality of storage controllers 202, each of which control a respective storage system 204. Host systems 212 may access memories within the hierarchical storage system via a bus interface. In one embodiment, the bus interface may be a non-volatile memory express (NVMe) or a fiber channel over Ethernet (FCoE) interface. In one embodiment, the system illustrated in FIG. 1C may be a rack mountable mass storage system that is accessible by multiple host computers, such as would be found in a data center or other location where mass storage is needed.

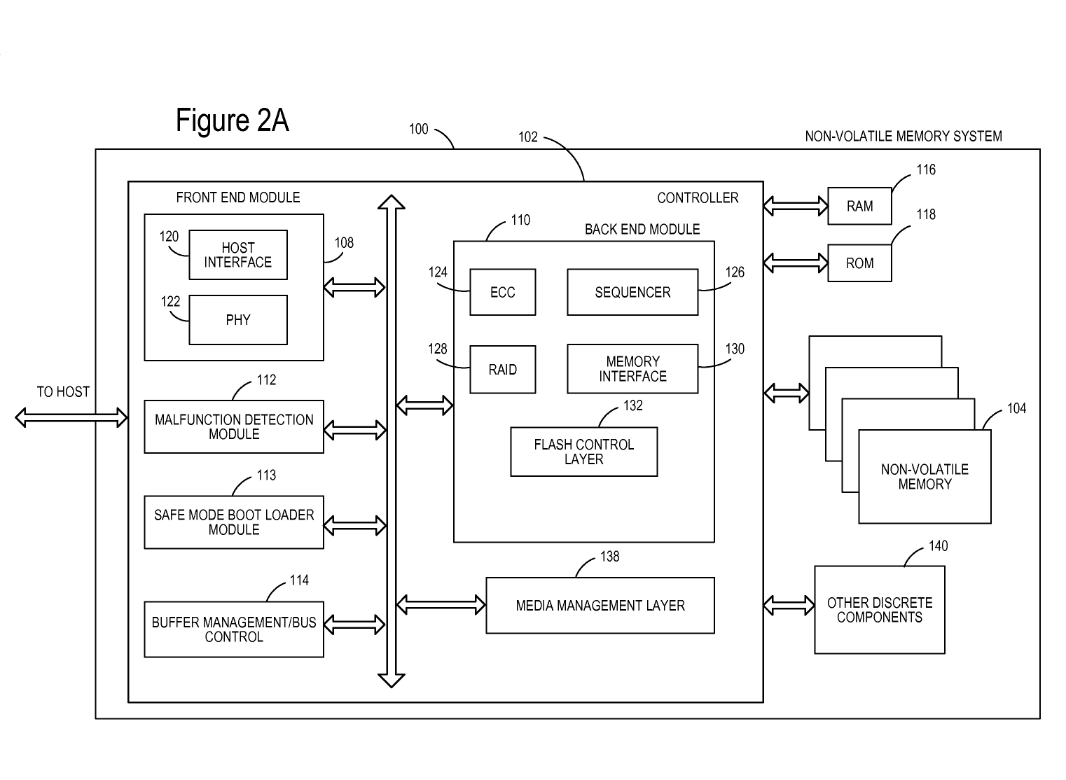

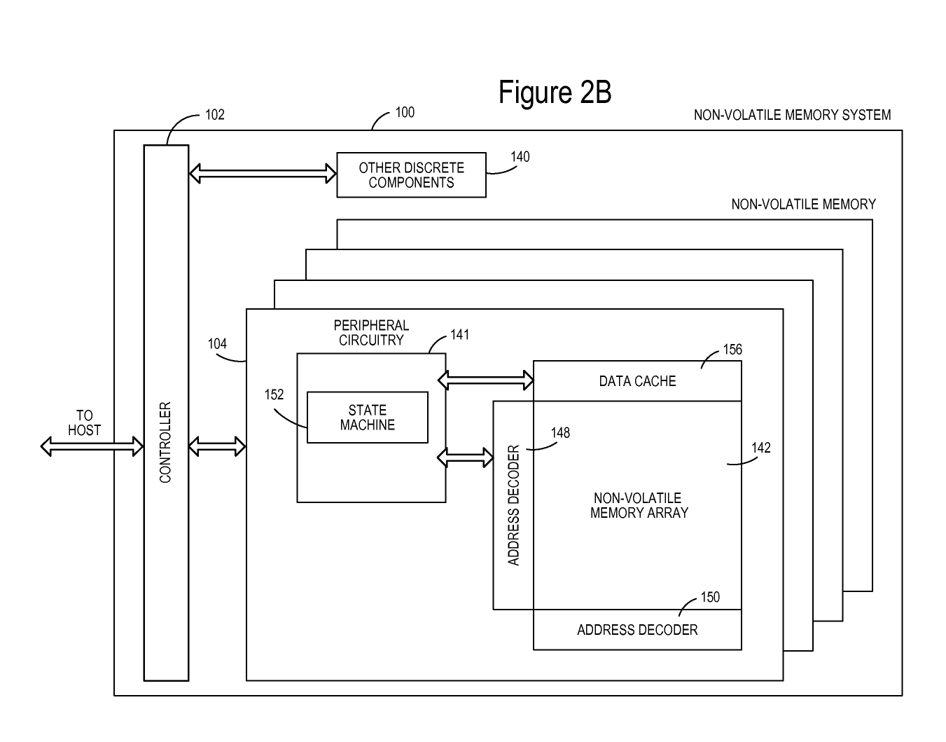

FIG. 2A is a block diagram illustrating exemplary components of controller 102 in more detail. Controller 102 includes a front end module 108 that interfaces with a host, a back end module 110 that interfaces with the one or more non-volatile memory die 104, and various other modules that perform functions which will now be described in detail.

A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of the memory 104, for example, that comprises instructions executable with a processor to implement one or more of the features of the module. When any one of the modules includes the portion of the memory that comprises instructions executable with the processor, the module may or may not include the processor. In some examples, each module may just be the portion of the memory 104 or other physical memory that comprises instructions executable with the processor to implement the features of the corresponding module.

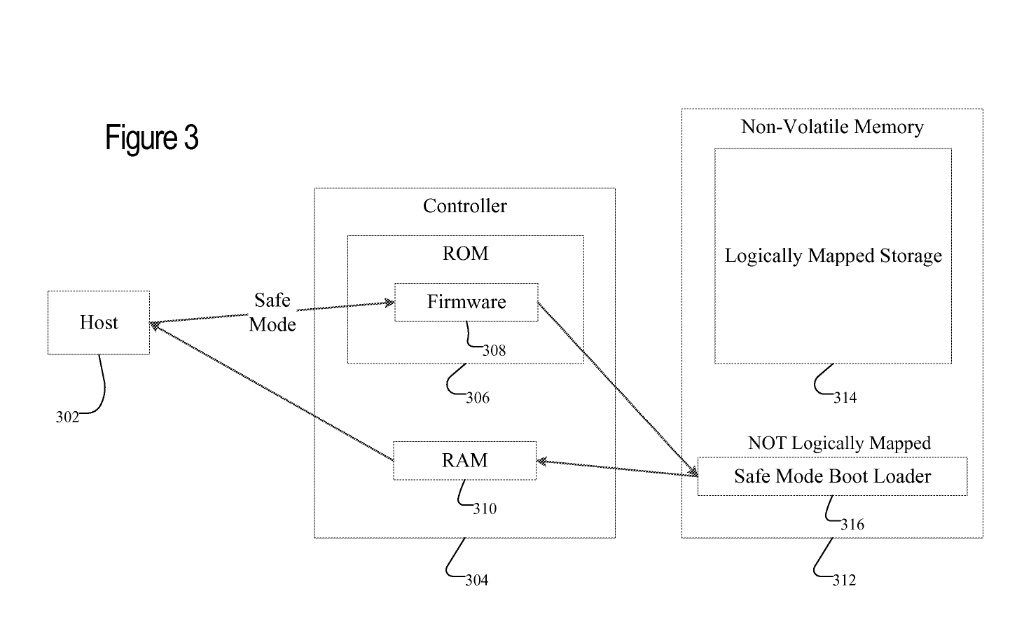

Modules of the controller 102 may include a malfunction detection module 112 and/or a safe mode boot loader module 113 present on the die of the controller 102. As explained in more detail below in conjunction with FIGS. 3-7, the malfunction detection module 112 may detect a malfunction with the memory system 100 and the host (e.g. the host cannot operate the operating system stored by the memory 104). When the system 100 detects a malfunction, a safe mode boot loader module 113 may operate to boot in safe mode. The safe mode operation may allow the host to operate debugging and/or recovery functions to repair the malfunction and properly boot the device. As described below, the safe mode boot loader code may be stored in an area of the memory 104 that is not logically addressed.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller. Further, in some implementations, the controller 102, RAM 116, and ROM 118 may be located on separate semiconductor die. In one embodiment, the ROM 118 may include firmware that provides the location for the non-addressed safe mode boot loader code such that the safe mode boot loader code is transferred to the RAM 116 for booting in safe mode.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, SAS, Fibre Channel, USB, PCIe, and NVMe. The host interface 120 typically facilitates transfer for data, control signals, and timing signals.

Back end module 110 includes an error correction controller (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the non-volatile memory system 100. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

Additional components of system 100 illustrated in FIG. 2A include media management layer 138, which performs wear leveling of memory cells of non-volatile memory die 104. System 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

The FTL or MML 138 may be integrated as part of the flash management that may handle flash errors and interfacing with the host. In particular, MML may be a module in flash management and may be responsible for the internals of NAND management. In particular, the MML 138 may include an algorithm in the memory device firmware which translates writes from the host into writes to the flash memory 104. The MML 138 may be needed because: 1) the flash memory may have limited endurance; 2) the flash memory 104 may only be written in multiples of pages; and/or 3) the flash memory 104 may not be written unless it is erased as a block. The MML 138 understands these potential limitations of the flash memory 104 which may not be visible to the host. Accordingly, the MML 138 attempts to translate the writes from host into writes into the flash memory 104. As described below, erratic bits may be identified and recorded using the MML 138. This recording of erratic bits can be used for evaluating the health of blocks.

FIG. 2B is a block diagram illustrating exemplary components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two dimensional and/or three dimensional configuration. Peripheral circuitry 141 includes a state machine 152 that provides status information to controller 102. Non-volatile memory die 104 further includes a data cache 156 that caches data.

FIG. 3 is a block diagram of another exemplary memory system using a safe mode boot loader. The host 302, controller 304 and the non-volatile memory (NVM) 312 are shown separately in FIG. 3, but in alternative embodiments they may be part of a single system (e.g. system on a chip SoC) in which the operating system for the host 302 is stored in the NVM 312. The controller 304 includes random access memory (RAM) 310 and read only memory (ROM) 306. The ROM 306 may include firmware 308 that provides boot instructions. As shown in FIG. 3, when safe mode is triggered, the host 302 accesses the firmware 308 in the ROM 306 which provides the location for the safe mode boot loader 316 on the NVM 312. In alternative embodiments, the firmware code that may be responsible for loading the safe mode boot loader 316 may be from a source (other than ROM), such as firmware that was previously loaded from NAND or EEPROM. The NVM 312 includes logically mapped storage 314. The logical mapping of the memory may include logical block addresses (LBAs). However, the safe mode boot loader 316 is not logically mapped so that it is not accidentally accessed. Accordingly, the firmware 308 provides the physical location in the NVM 312 for the safe mode boot loader 316. Once accessed from the firmware 308 in the ROM 306, the safe mode boot loader 316 code is transferred to the RAM 310 which is accessed by the host 302. Using the safe mode boot loader 316, the host 302 may boot despite the malfunction that triggered the safe mode.

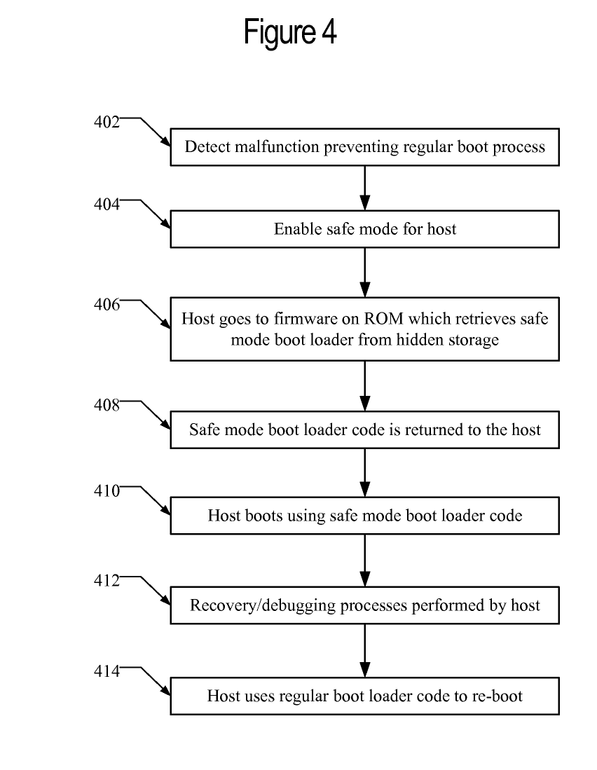

FIG. 4 is a flow diagram illustrating safe mode boot loading. The safe mode boot loading described with respect to FIG. 4 may be implemented with any of the systems shown in FIGS. 1-3. A malfunction may be detected in block 402. The malfunction may prevent the regular boot process and may be detected by the malfunction detection module 112. The detection may be based on the number or frequency of unsuccessful initialization attempts. For example, there may be a threshold value for initialization attempts after which safe mode is entered. For example, the device may be allowed ten attempts to initialize, after which the device triggers safe mode. Other examples by which a malfunction is self-detected may include identifying that logical block address (LBA) 00 is corrupt.

When the malfunction is detected, the system may enable safe mode for the boot process as in block 404. When in safe mode, the host performs a logical read of boot loader logical addresses (same addresses as regular boot-loader) to access the safe mode boot loader from hidden (not logically addressed) storage in block 406. The safe mode boot loader code is returned to the host after being stored in RAM as in block 408. The host utilizes the safe mode boot loader code to boot in safe mode as in block 410. Because the malfunction prevented any booting, the safe mode booting allows the host to perform recovery and/or debugging processes in block 412. Upon recovery or fixing of the malfunction (from the safe mode), the host can then access the regular boot loader and boot according to the regular (not safe mode) booting process in block 414.

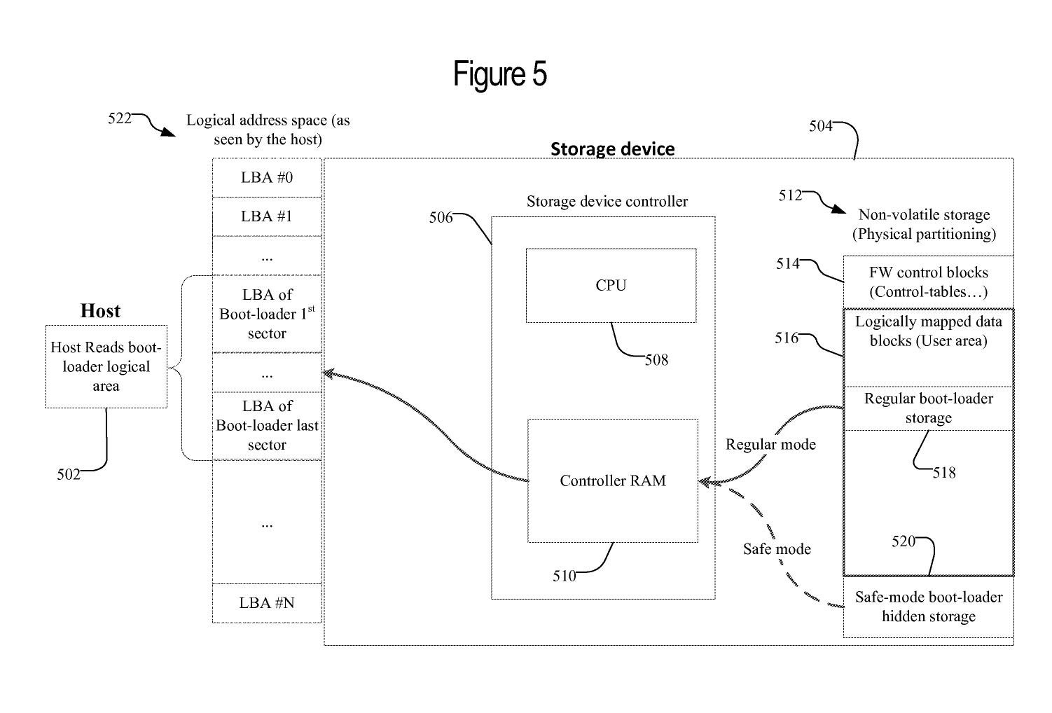

FIG. 5 is a block diagram of another exemplary memory system using a safe mode boot loader. FIG. 5 illustrates an exemplary embodiment of the memory system that is similar to FIG. 3. The host 502 access the logical address space 522 of the storage device 504. The logical address space 522 is the logical mapping of the non-volatile storage 512. The storage device 504 includes a storage device controller 506 and the non-volatile storage 512. The storage device controller 506 includes a computer processing unit (CPU) 508 and controller RAM 510. The non-volatile storage 512 includes firmware (FW) control blocks 514, logically mapped data blocks 516 and regular boot loader storage 518. The data stored in 514-518 is logically mapped and the host can access that data with the logical address space 522. However, a safe mode boot loader hidden storage 520 is also included in the non-volatile storage 512, but is not logically mapped. When the host boots in regular mode, the regular boot loader storage 518 code is transferred to the controller RAM 510 and is accessed from the logical address space 522 by the host 502 for proceeding with a regular boot. Upon a malfunction, the host 502 may not be able to access the regular boot loader storage 518 (e.g. there is an error in the code or in the logical address space), so the storage device implements safe mode. During safe mode, the safe mode boot loader 520 is loaded into the controller RAM 510 and is accessible to the host 502 for booting in safe mode. Once booted in safe mode, the malfunction can be identified and fixed.

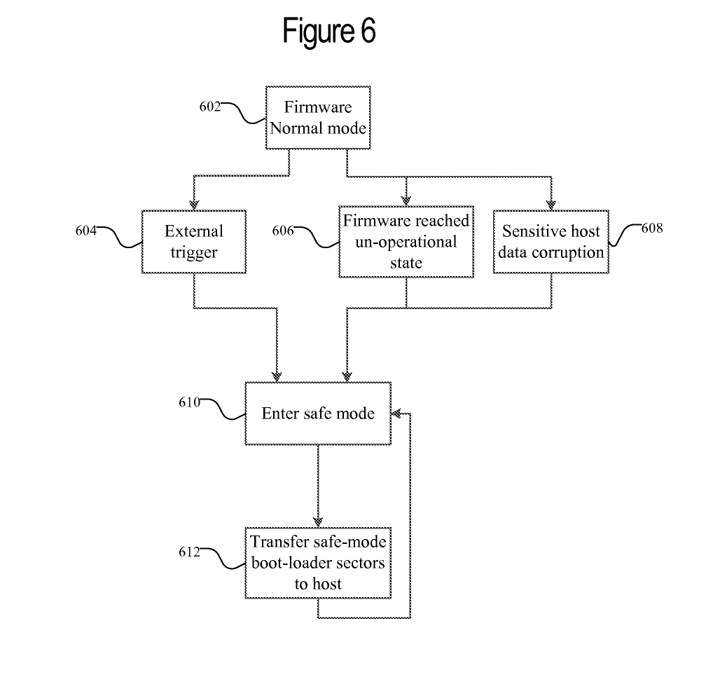

FIG. 6 is a flow diagram illustrating entry into a safe mode boot loading process. In one embodiment, the entry into the safe mode may be based on the storage device detecting a malfunction that prevents regular booting. There may be other triggers for entry into safe mode. In block 602, the firmware may be operating in normal/regular (non-safe) mode. Exemplary triggers to enter the safe mode in block 610 are shown in blocks 604-608. When in safe mode, safe mode boot loader sectors are transferred to the host in block 612.

The exemplary triggers for safe mode in blocks 604-608 include an external trigger 604. The external trigger 604 may be a special command from the host that triggers safe mode. The host may detect an error or malfunction condition and issue the special command, which should be an unambiguous signal that cannot be triggered by mistake. Likewise, the external trigger 604 may be a special sequence that is sent to a peripheral communication channel (e.g. a universal asynchronous receiver/transmitter (UART), Joint Test Action Group (JTAG), etc.). For example, in the case of eMMC devices, a vendor specific command CMD64 may be defined as a CMD64 command and a 32 bit unique pattern (e.g. 0x5AFEB007). Finally, the external trigger 604 may include a general-purpose input/output (GPIO) sequence for booting the device externally. Rather than an external trigger 604, the storage device may detect a malfunction and trigger its own entry into safe mode operation. For example, the storage device may detect that the firmware has reached an un-operational state in block 606. In other words, if initialization fails, the storage device can trigger safe mode.

The storage device may also detect sensitive host data corruption as in block 608. This self-detected malfunction can also cause the storage device to enter safe mode. The sensitive host data may include the original/regular boot loader or operating system files. The data corruption may include an identification of uncorrectable errors. In one example, the firmware may detect uncorrectable errors when reading the original/regular boot loader or other operating system logical sectors. In one embodiment, the firmware may manage the boot loader sectors and keep them uncorrupted by handling data retention issues, keeping redundant copies, and/or performing error correction with low density parity check (LDPC).

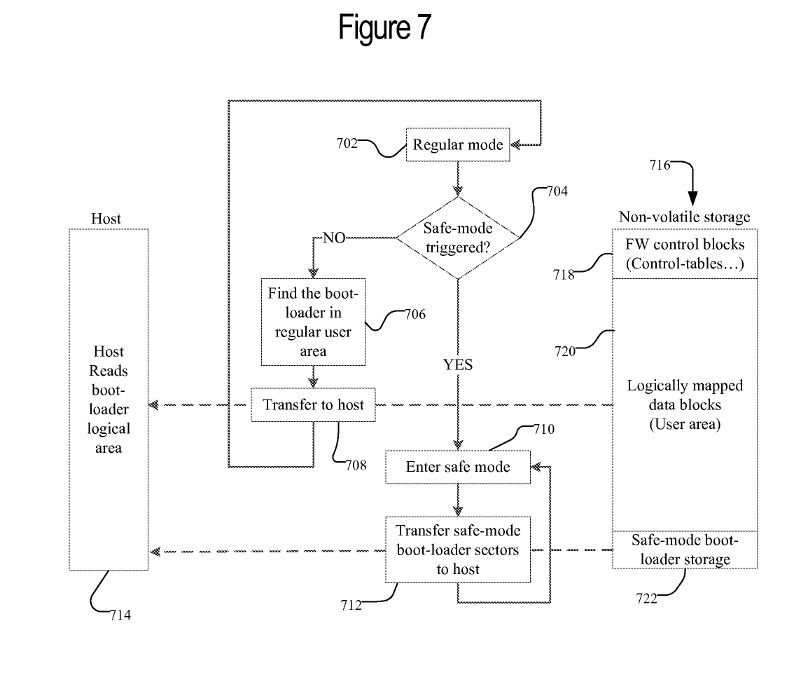

FIG. 7 is a flow diagram illustrating another embodiment of safe mode boot loading. In block 702, the storage device may be operating in regular mode. The safe mode trigger is determined in block 704. When safe mode is not triggered, then the boot loader is retrieved from the logically mapped data blocks 720 in the non-volatile storage 716. This regular boot loader is transfer to the host in block 708. The host reads the boot loader logical area in block 714. When the safe mode is triggered in block 704, then the safe mode is entered in block 710. When in safe mode, the safe mode boot loader storage 722 is transferred to the host 714 in block 712. The non-volatile storage 716 includes firmware control blocks 718, logically mapped data blocks 720, and safe mode boot loader storage 722 that is not logically mapped. When in regular mode, the regular boot loader is loaded from the logically mapped data blocks 720. When in safe mode, the safe mode boot loader storage 722 is loaded to the host 714 from an area of non-volatile storage 716 that is not logically mapped.

By storing the safe mode boot loader in a location that is not logically mapped, it is less likely to be accidentally run. The data integrity may be guaranteed by any of the following: 1) protecting the safe mode boot loader with LDPC engine; 2) keeping the safe mode boot loader in high-endurance memory region (in single level cells (SLC) blocks in flash); 3) keeping redundant copies; and/or 4) handling any data retention occurrences. The location storing the safe mode boot loader is characterized by low write and read cycles. In most cases, it is written only once in a special write session, and rarely read.

When the safe-mode is triggered, the storage-device firmware may enter a special mode of operation. In this mode, the firmware may perform limited operations. In one embodiment, it may perform only three basic operations: 1) fetching the location of the safe mode boot loader sectors in the non-volatile memory; 2) upon a host read of the boot loader logical area, sectors from this location may be read to ASIC RAM; and 3) transferring sectors to host. When the host reads from boot loader logical area, the device may transfer the safe mode boot loader sectors from the special non-volatile location.

The use of safe mode may enable recovery operations or debugging to occur regarding the malfunction. In particular, many recovery or diagnostic testing operations require the host to be operational which is not the case if the malfunction prevents booting. Exemplary debugging processes that may be performed when in safe mode (that would otherwise be unavailable due to the malfunction) include: 1) reading different host or device (firmware) logs; 2) testing the OS image for file corruptions by reading the entire media; 3) sending diagnostic commands to device; 4) performing host based firmware download or field-firmware-upgrade; and/or 5) operating tools such as a memory analysis tool. The firmware download may even allow running a fully operational OS. The boot loader may download all the necessary OS files from an alternative communication channel (e.g. USB, WiFi, SecureDisk cards, etc.) and run the OS. In this case, the boot loader may only require a minimal driver that will allow setup and running the chosen communication channel for this purpose.

In the present application, semiconductor memory devices such as those described in the present application may include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magneto-resistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure. In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate). As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory. In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

It is intended that the foregoing detailed description be understood as an illustration of selected forms that the invention can take and not as a definition of the invention. It is only the following claims, including all equivalents that are intended to define the scope of the claimed invention. Finally, it should be noted that any aspect of any of the preferred embodiments described herein can be used alone or in combination with one another.

We claim:

1. A method for alternative booting of a memory device, the method comprising:
detecting a malfunction on the device;
accessing safe mode boot loader code from an area of memory on the memory device that is not logically addressed; and
allowing for booting in safe mode by using the safe mode boot loader code.

2. The method of claim 1 wherein the alternative booting comprises a safe mode that is booted with the safe mode boot loader code, and further wherein a regular boot loader is stored in logically mapped memory for a regular booting process that is different from the alternative booting in the safe mode.

3. The method of claim 2 further comprising:
correcting the malfunction while in the safe mode; and
initiating the regular booting process after the malfunction is corrected.

4. The method of claim 1 wherein the accessing the safe mode boot loader code further comprises:
receiving an indication of entry into a safe mode upon the detection of the malfunction;
receiving a physical location of the safe mode boot loader code from the firmware on the read only memory (ROM); and
retrieving the safe mode boot loader code from the received physical location.

5. The method of claim 1 wherein the detecting a malfunction comprises:
counting a number of failed initializations; and
identifying the malfunction when the number exceeds a threshold.

6. The method of claim 1 wherein an operating system for a host is stored in the memory on the memory device.

7. The method of claim 6 wherein the booting in safe mode comprises:
transferring the safe mode boot loader code to random access memory (RAM); and
providing the safe mode boot loader code to a host.

8. The method of claim 6 wherein the detecting comprises identification by the memory device rather than a host.

9. The method of claim 1 wherein the memory comprises non-volatile memory, further wherein the non-volatile memory comprises flash memory.

10. The method of claim 9 wherein the flash memory comprises a three-dimensional (3D) memory configuration, and wherein a controller is associated with operation of and storing to the flash memory.

11. A storage device comprising:
a read access memory (RAM);
a non-volatile memory with logically mapped storage that stores a regular boot loader and with un-mapped storage that stores a safe mode boot loader;
a controller that accesses the RAM and non-volatile memory and is configured to trigger safe mode operation upon detection that regular booting is inoperable, wherein the safe mode operation comprises loading the safe mode boot loader into RAM.

12. The storage device of claim 11 further comprises:
a read only memory (ROM) with firmware that provides a location to the safe mode boot loader.

13. The storage device of claim 12 wherein the triggering of the safe mode operation further includes retrieving the location of the safe mode boot loader from the firmware.

14. The storage device of claim 13 wherein the controller provides the safe mode boot loader to a host for booting with the safe mode operation.

15. The storage device of claim 13 further comprising:
a malfunction detection module that detects a malfunction, wherein the regular booting is inoperable when the malfunction is detected, further wherein detection of the malfunction triggers the safe mode operation; and
a safe mode boot loader module that boots in the safe mode when the malfunction detection module detects the malfunction.

16. The storage device of claim 11 wherein the regular booting is inoperable when a host device coupled with the storage device fails to initialize properly.

17. A memory system for booting in a safe mode, the system comprising:
a non-volatile memory that stores regular boot loader code and a safe mode boot loader code, wherein the safe mode is established from booting with the safe mode boot loader code;
a malfunction detection module that detects a malfunction with a regular booting process through the regular boot loader code; and
a safe mode boot loader module that triggers, upon detection of the malfunction, the safe mode with the safe mode boot loader code.

18. The system of claim 17 further comprising:
a controller that manages the non-volatile memory, wherein the controller includes both the malfunction detection module and the safe mode boot loader.

19. The system of claim 17 wherein the safe mode boot loader code is stored in an area of the non-volatile memory that is not logically addressed.

20. The system of claim 19 wherein the safe mode boot loader code is accessed through firmware in the read only memory that provides a location for the safe mode boot loader code only when in the safe mode.
